(19) United States
(12) Patent Application Publication
(10) Pub. No.: US 2009/0171749 A1
(43) Pub. Date: Jul. 2, 2009

(54) Method for Dynamic Advertisement Placement Based on Consumer and Response Capability Statistics

(76) Inventors: Frederic Laruelle, Daly City, CA (US); Brian Galvin, Seabeck, WA (US)

Correspondence Address: CENTRAL COAST PATENT AGENCY, INC, 3 HANGAR WAY SUITE D, WATSONVILLE, CA, 95076, US

(21) Appl. No.: 11/965,626

(22) Filed: Dec. 27, 2007

(51) Int. Cl. G06Q 30/00

(52) U.S. Cl. 705/10; 705/14

(57) ABSTRACT

A network-based processing server for processing statistics and serving advertisements includes a first network interface to a first stat server for receiving consumer statistics, a second network interface to a second stat server for receiving response capability statistics, and a dedicated input/output port connecting the processing server to a broadcast network. The processing server selects and serves advertisements over the broadcast network to consumers positioned to receive the advertisements based on the processing of consumer statistics and advertisement response capability statistics against at least one rule.

### BACKGROUND OF THE INVENTION

1. Field of the Invention

The present invention is in the field of “opt-in” advertising to a consumer base and pertains particularly to methods and systems for placing advertisements based on consumer and response capability statistics measured at the time of placement.

2. Discussion of the State of the Art

In the field of advertising, it is more and more common to target consumers with target advertising where the ads are selected and served in part due to some information that is known about the consumer or consumer group that will receive the ads. In passive advertising, ads are sent on an opt-in basis meaning that the advertising is presented to consumers that may take an “option” of interacting with the ad (if interactive) or at least contacting the advertiser to engage further in the process of an advertisement often leading to some transaction. There are many different mediums over which advertisements may be presented to consumers. The more traditional mediums include print advertising, radio advertising, and television advertising.

With the growth of the Internet network, Email advertising and Web page advertising including Internet search result page advertising have become primary vehicles for opt-in advertising. Targeting methods for electronic advertising include targeting consumers based on search keyword, browser behavior, navigation history, profile information, likes or dislikes, survey response, GPS coordinates, and so on. For electronic advertising, typically a consumer receiving the advertisement may interact with it to initiate a process which represents the goal of the advertisement.

The inventors are aware of a system for serving electronic advertisements over a data packet network. The system listed above in the cross-reference section of this specification includes a server connected to the data packet network, a data storage accessible to the server for holding advertisements for service and associated data, and a software instance running on the server for selecting and causing placement of advertisements including selected associated data. Advertisements are selected and served based on some real time information accessible to the software instance. The associated data may be contact information that may be embedded into or deployed with the advertisements based at least in part on evaluation of the real-time information accessed. The system designed for Internet-based Web advertising looks at consumer behavior for triggering target advertising and response availability for selecting contact information to serve with the advertisement increasing the chance that a resulting ad interaction will be better serviced.

One challenge with this type of opt-in advertising designed for Web pages is that there are typically a number of competing advertisements presented simultaneously to the consumer using essentially the same target criteria. So even though an ad is presented that may fit a consumer profile or match what the consumer is at least searching for through a search engine, the opt-in rate defined as the percentage of consumers who will interact with a particular advertisement may be forced lower due to competing ads presented at the same time in the same consumer space.

It has occurred to the inventors that multimedia advertising such as video/audio commercial ads may be designed to be interactive for those consumers who may receive them over interactive television networks and customer premise equipment (CPE) associated with those networks such as Internet Protocol Television (IPTV) for example. The presentation of time-based advertising into a medium like television programming is much more challenging than a Web-based text or graphic advertisement. Moreover, there are potentially untapped methods of determining consumer pre-disposition to certain types of commercial advertising that may be delivered over an interactive multimedia-based system like interactive television. Still further, it has occurred to the inventor that there may be more granular methods envisioned for ad specialization to consumers based on consumer identity, which is less certain in some Web-based advertising channels that enable the consumer to remain virtually anonymous through various methods such as temporary email accounts for example.

Therefore, what is clearly needed is an improved system and methods for creating and delivering advertising in a way that ensures the ability to target consumers without reducing opt-in rates and maximizes ad response by throttling advertisement delivery according to both sides of the service equation.

### SUMMARY OF THE INVENTION

The problem stated above is that more flexibility in targeting consumers for advertising is desirable in any advertising environment, but many of the conventional means for advertising, such as to Web pages, search result pages and the like do not provide discoverable opportunities for optimized advertising that targets consumers on a more personal level. The inventors therefore considered functional elements of advertising systems that could potentially be harnessed to provide more flexibility in consumer targeting and that would enable optimized use of resources assigned to fulfill the goals of the advertisements.

Every opt-in advertisement system has normal opt-in rates. Most such systems lack the type of personalization to consumers required to significantly raise opt-in rates. The present inventor realized in an inventive moment that if, at the point of ad placement, the ads could be placed in a manner that is more personal to the consumer and ad delivery could be throttled based on response capability, significant opt-in rate increases might result and best utilization of ad fulfillment resources could be realized. The inventor therefore constructed a unique advertisement system for placing advertisements that allowed more personal and dynamic ad delivery increasing opt-in rates and optimizing utilization of ad fulfillment resources. Opt-in rates to targeted consumers are greatly increased and fulfillment resources are more intelligently used.

Accordingly, a method is provided for determining advertisement placement service instructions for placing an advertisement comprising the steps of (a) receiving from an advertiser, one or more advertisements and a set of conditional service instructions, (b) monitoring consumers positioned to receive the one or more advertisements and compiling statistics about them as a group, (c) before a pending advertisement service point, receiving statistics about response capabilities for handling interactions resulting from a served advertisement, (d) before the pending advertisement service point of step (c), comparing the consumer group statistics with the response capability statistics against at least one rule, and (e) delivering or not delivering an advertisement of the one or more advertisements of step (a) at the advertisement service point of step (c) using one or more of the conditional service instructions based on the result of step (d).

According to another aspect, a method is provided for selecting an advertisement for insertion into a time slot available to more than one advertiser comprising the steps of (a) receiving from the advertisers an advertisement and a set of conditional service instructions, (b) monitoring consumers positioned to receive the one or more advertisements and compiling statistics about them as a group, (c) before the time slot occurs, receiving response capability statistics from all associated centers assigned to handle advertisement interactions resulting from advertisement service, (d) before the time slot of step (c), comparing each of the center's response capability statistics with the consumer group statistics against at least one rule, and (e) selecting an advertisement for insertion into the time slot, the advertisement pre-assigned to an associated center according to the result of step (d).

According to another aspect, a system for dynamic advertisement placement to a base of consumers is provided comprising an advertisement server for causing service of advertisements to the consumer base, and a statistics processor coupled to the advertisement server. The advertisement server receives consumer group statistics from consumers positioned to receive advertisements, and receives response capability statistics from one or more centers positioned to respond to consumers who interact with advertisements served and processes those statistics using the statistics processor against at least one rule to determine advertisement service instructions for serving or for not serving particular advertisements.

According to another aspect, a network-based processing server for processing statistics and serving advertisements is provided comprising a first network interface to a first stat server for receiving consumer statistics, a second network interface to a second stat server for receiving response capability statistics, and a dedicated input/output port connecting the processing server to a broadcast network. The processing server selects and serves advertisements over the broadcast network to consumers positioned to receive the advertisements based on the processing of consumer statistics and advertisement response capability statistics against at least one rule.

According to another aspect, a method for controlling deployment parameters of an advertisement created for a consumer base and served by an advertisement placement service comprising the steps (a) providing a set of advertisement service instructions and constraints to an advertisement placement service, (b) providing response capability statistics relative to the advertisement to the advertisement placement service, (c) providing consumer group statistics about consumers positioned to receive the advertisement to the advertisement placement service, (d) at the advertisement placement service, processing the statistics provided in steps (b) and (c) against at least one rule, (e) selecting from the service instructions and constraints of step (a) those that will be used in deploying the advertisement based on the result of step (d), and (f) repeating steps (b) through (e) before each subsequent period of advertisement placement.

### BRIEF DESCRIPTION OF THE DRAWING FIGURES

FIG. 1 is an overview of an advertisement delivery network system according to an embodiment of the present invention.

FIG. 2 is a block diagram illustrating statistics processing for ad service instruction determination for advertisement delivery according to an embodiment of the present invention.

FIG. 3 is an overview of an advertisement delivery network according to another embodiment of the present invention.

FIG. 4 is a block diagram illustrating ad service delivery statements made according to advertisement delivery instructions and statistics processing.

FIG. 5 is a process flow chart illustrating steps for determining ad service according to embodiments of the present invention.

### DETAILED DESCRIPTION

The inventors provide an advertisement delivery system and methods whereby advertisement service instructions are determined for dynamic advertisement service based on statistics processing of consumer-based and response capability statistics.

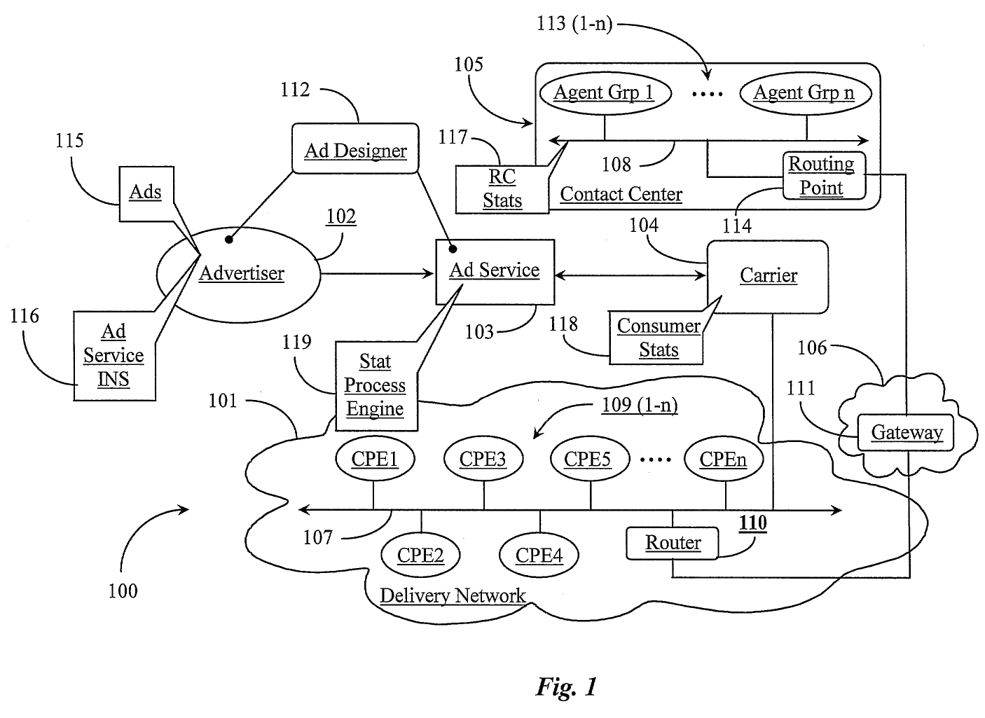

FIG. 1 is an overview of an advertisement delivery network system 100 according to an embodiment of the present invention. For the purposes of discussion the term advertisement shall mean any advertisement presentation that may be delivered to a consumer device. The term advertisement may be shortened to the term ad in this specification and both terms shall have the same broad definition. The advertisements may or may not be interactive; an example of the present invention with a non-interactive advertisement is an advertisement which provides an 800 number that consumers can dial. It is still advantageous to preferentially show such a non-interactive ad when resources are actively available, as opposed to times when there are no available resources.

Network system 100 includes an ad delivery network 101. Ad delivery network 101 may be a data packet network or network segment defined as a delivery network over which ads may be broadcast, multi-cast, or delivered to a subscriber base of consumers that receive multi-media services such as interactive television services, for example. Delivery network 101 is, in one embodiment, an Internet Protocol Television (IPTV) delivery network reserved for provision of broadcast or interactive television and other IP-based services such as Internet services and IP telephone services. Generally speaking, an IPTV service network is one where instead of more traditional unidirectional media delivery such as with cable systems or satellite systems, the media is delivered over a data packet network that is fully bi-directional such as the Internet network, for example. Broadband, digital subscriber line (DSL) services may be employed in the delivery architecture. In one embodiment however, delivery network 101 may be a cable network adapted for two-way communication and may therefore be adapted for delivery of IPTV services. Additionally, the invention may be carried out in an embodiment where the delivery network is a traditional over-air radio or television broadcast network.

Delivery network 101 may be a private fee-based network provided for the purpose of enabling viewers to subscribe to one or more “bundled” services like high definition television (HDTV), Voice over Internet Protocol (VoIP) telephone services and Internet connection services for Internet navigation purposes. Such bundling of services is often termed a “triple play” in the art where a consumer's television equipment, telephone equipment, and computer equipment, collectively referred to herein after as customer premise equipment (CPE) are all serviced over the same network. In one embodiment, delivery network 101 is the Internet network and requires no service contract or other authorization to use to obtain free IPTV channels that may be made available for anyone with a computer and an Internet connection.

Delivery network 101 is further defined logically by a network backbone 107 to which consumer CPE 109(1-n) have connection to in order to receive services. CPE may include television, telephone and computer equipment as previously described above. In one embodiment, session initiation protocol over Internet protocol (SIP/IP) is the primary protocol for delivering consumer services over network 101.

Services are enabled and provided in one embodiment by a service carrier 104. Carrier 104 may be any service provider that provides and maintains service architecture and provides a “head end” from which multi-media programming may be originated delivered over the network to consumers. Carrier 104 primarily provides the programming that consumers operating CPE 109(1-n) would receive on their television equipment. However, such programming may also be re-directed to a computer or a third generation (3G) mobile telephone, or over a radio broadcast network including one broadcast over a network such as the Internet. Therefore, the multimedia programming provided is not limited to just television display.

In addition to providing a head end for programming delivered over the network, carrier 104 may also provide IP telephone services and Internet connection services as previously described. Therefore, all of a consumer's CPE may be classed as “edge devices” having network addresses on the same network. Likewise, all of a consumer's devices may be simultaneously operating on the same network and receiving services over the same network. Optional CPE configurations may exist for enabling consumers to consolidate multiple services to be practiced from one edge device or segregated over multiple edge devices.

Consumer edge devices may be enabled to communicate with a router 110 and may be considered as destination and source devices in a routing strategy using SIP/IP. Therefore, each device connected to a CPE may be readily identifiable by network address, device type, CPE owner (consumer ID). A SIP registrar handles SIP registration for each consumer edge device. Other identification parameters that can be used in practice of the invention include consumer telephone number(s), consumer account number(s), and more granular identifiers like consumer email addresses and instant message handles. In one embodiment, personalized remote settings can be used to identify a consumer in a household of consumers that share a same set of CPE. In some target advertising embodiments special advertising may be delivered based on consumer identity and the consumer's known relationship with existing products or services.

Carrier 104 may deliver both scheduled programming and video on demand services using appropriate protocols for video encoding and real time video streaming. Advertising may be provided over delivery network 101 to CPE 109(1-n) in commercial time slots inserted in the typical programming that is available. The advertisements may be multimedia video/audio ads that are interactive in the sense that a consumer may select the advertisement or some component within the advertisement and initiate a process, which is the goal of the advertisement.

Such advertisements may be time-based ads that are inserted into available time slots provided within the programming that is to say within television shows and between television shows like standard commercial television advertisement. Interactive advertisements may also be served independently from any television programming such as being made to appear at the bottom of the visible screen, as a small floating window, a window within a window, (pic-on-pic), etc. The advertisement may also be completely visual with no audio, or perhaps a text ad like a Really Simple Syndication (RSS) feed moving across the bottom or top portion of the television screen. In one embodiment, ads may be delivered to consumer edge devices other than the television such as a cell phone, computer or radio.

For general purposes, commercial time-based advertising into television programming will be the focus of this example and subsequent examples presented herein. However, the present invention may be practiced using other types of advertising and may incorporate different consumer edge devices for ad display without departing from the spirit and scope of the present invention.

Network system 100 includes at least one advertiser 102. Advertiser 102 may be any entity providing goods and/or services that may provide advertising to be delivered to CPEs 109(1-n). In one embodiment, an advertiser designs or creates advertising and includes an ad designer 112, which may be a live attendant operating a tool kit or otherwise is capable of creating advertising for the advertiser. In one embodiment, ad designer 112 is an entity that is separate from the advertiser. For example, the ad designer may be part of an ad service 103. Ad designer 112 may also be a single dedicated third-party entity hired by the advertiser to create ads. Ad service 103 may be any entity that is capable of causing advertising to be placed. Ad service 103 may also be a third party service available for hire and may or may not include ad designer 112.

Ad service 103 has a network connection to carrier 104 and may coordinate with carrier 104 to insert advertisements into programming delivered by carrier 104. Advertiser 102 has one or more advertisements (Ads) 115 that may be delivered to CPEs 109(1-n). In one embodiment, advertiser 102 also has ad service instructions 116 that relate to how and under what conditions advertisements will be served. Ad service instructions 116 are at least a set of instructions and conditions for serving a particular ad or more than one particular ad. Ad service 103, in this case, actually serves the ads according to the instructions and constraints that are part of the ad service instructions.

System 100 also includes at least one contact center 105 for responding to customer inquiries initiated in response to served advertisements. Contact center 105 may be a third-party service hired by the advertiser 102 to respond to consumer inquiries. In one embodiment, the advertiser 102 maintains contact center 105 “in house”. In this type of advertising, consumers (CPE1-n) opt-in (interact) with the served advertisement, or as a result of viewing said ad they contact the advertiser with inquiries. As one of the key goals of advertising is to stimulate interaction between the target consumers and the advertiser, the use of the invention results in an increase in the probability that an interaction will occur with a consumer who interacted with an ad, the interaction conducted by center 105 in this example.

Center 105 includes a local area network (LAN) 108 that supports contact center equipment and resources such as a routing point 114 and agent groups 113(1-n) poised to answer or to handle interactions resulting from consumers interacting with served advertisements. In this logical diagram, LAN 108 within contact center 105 is accessible from network 101 via router 110, a gateway 111 within an intermediary communications network 106, and routing point 114. Network 106 may be any type of intermediary network and is not specifically required in order to practice the present invention.

For example, network 101 may be a cable network adapted for IPTV and network 106 may be the well-known PSTN network. In this case, ad interaction may result in incoming telephone calls to contact center 105, which may be handled by agent groups 1-n using standard telephone connections. In that case, gateway 111 would represent a gateway enabling VoIP to PSTN-based telephony connections. In another example, delivery network 101 may be a private IP segment and network 106 may be the public Internet network. In still another embodiment, network 101 may be a wireless IP network and network 106 may be a wired IP network. One with skill in the art will appreciate the overlapping of various network architectures and that communications may traverse network architectures through numerous routers and gateways of various types. The exact architecture presented herein is logical only and should not be construed in any limited way.

In practice of the present invention, it is desired by the advertiser to serve advertising to consumers in a way that maximizes opt-in rates and wherein timely treatment of consumers interacting with the advertising is available at the time of ad placement. For the purpose of discussion only, it may be assumed that advertising in this example is commercial, time-based interactive ads and that consumer interaction therewith results in incoming calls into contact center 105 connecting consumers to live agents waiting to handle resulting calls. The incoming calls may be the result of outbound call placed to consumers who have interacted with the advertising served. One with skill in the art will appreciate that other interaction and channel combinations may be observed without departing from the spirit and scope of the invention.

Contact center 105 monitors agent groups 113(1-n) for agent availability. Agent availability may be monitored across multiple channels and is not limited to availability for live telephone. At any given time during an advertising campaign, response capability (RC) statistics 117 for all agent groups 113(1-n) may be provided or made available to an entity charged with determining service requirements of ad service. RC stats 117 may include numbers of available agents currently available in any agent group.

Agent availability for live interaction is used in this example for discussion purposes only because the availability statistic is relevant to a desire by the advertiser to deliver advertising based at least in part on “response capability”, which can refer to live assistance or to automated assistance which may also be restricted in capacity or capability. The key concept is that consumers who click on advertising, or decide to make a telephone call to be connected to a live operator or agent may become dissatisfied and agitated in some cases if they have to wait too long for an agent or if no live assistance is available. Rather than serve the advertising when no agent will be available, RC statistics play a role in how the ad service is carried out. Ad service instructions 116 provide the basis for ad service but are not static instructions. For example, a set of ad service instructions 116 may include conditions and variable instruction sets for ad service according to one or more “conditions on the ground” that are born to light by the current statistics. In one embodiment, RC statistics 117 are provided by a statistics server and made available to clients of the server both internal to and external from contact center 105.

Carrier 104 has the capability of compiling statistics about consumers operating CPE 109(1-n). Carrier 104 collects consumer statistics 118. Consumer statistics may include number of total viewers, a list of telephone numbers of active viewers, a list of names of active viewers, and other statistics that may be provided based on information already known about the consumers by the carrier. For example, viewing histories of pay-per-view (PPV) activities of consumers might be accumulated to determine viewing habits or tastes. Other types of more granular statistics can be included in consumer statistics 118 some of which will be described later in this specification. Consumer statistics 118 like RC statistics 117 may also be made available to clients through a stat server. In this case, the client that may require both sets of statistics is ad service 103.

Ad service 103 obtains ad service instructions 116 for serving one or more ads 115. Before serving an ad based on instruction 116, the ad service acquires RC stats 117 from contact center 105 and consumer stats 118 from carrier 104. A statistics processing engine 119 is provided within ad service 103 and adapted to process RC and consumer statistics against ad service constraints, thresholds, or other values to determine by processing result which set of available ad service instructions for serving an advertisement will be selected and followed for placement of an advertisement. In the case of time-based advertisements that are inserted into available pre-paid ad slots in programming, a statistics processing routine may be run with the most current statistics before each ad insertion point during a program. An ad service decision may be made on a more general basis such as for an entire program, or on a more granular basis such as for each available ad slot.

Carrier 104 can determine total viewership with a granularity to exact number and identification of each viewer for video on demand and for general programming. With respect to other edge devices besides televisions, such as HDTVs, carrier 104 has the capability of determining which other CPE devices might be available or “online” while a consumer is watching television by virtue of the fact that in bundled services, all of the edge devices are identifiable by network address.

An advertiser may provide a set of ad service instructions 116 for an advertisement 115 that may be inserted into one or more ad service slots available to the advertiser in a given program for example. The advertiser may place certain conditions in instruction set 116 that must be met before placing advertisement 115. Conditions may be relative to RC statistics 117 or consumer statistics 118 or both consumer and response capability statistics. An expected opt-in rate may be used to “predict” a number of viewers that might respond to advertisement 115, which could help predict the number of agents that should be available for placing a specific number of advertisements.

In one embodiment dynamic placement of ads includes deciding which of more than one ad to serve and how many instances of service will occur relative to a total number of viewers positioned to view and interact with the advertisement. Ad service throttling or pacing may be implemented as a result of current RC statistics. Advertising may be served based on discovered relationships between viewers and advertisers that may be revealed by statistics. For example, of a total number of program viewers, there may be X number of viewers that also are current account holders of an advertiser. In a case such as this, an advertiser might desire that all of the viewers whom are also account holders be served a special advertisement such as an upgrade offer while the rest of the viewers receive a more general services advertisement. In a case where a number of active program viewers can be identified as current customers of the advertiser, then more information about those customers might be leveraged to dynamically advertise to those particular viewers.

Statistics processing and ad service determination takes place before an advertisement slot (ad insertion point) occurs in the programming. For any ad insertion slot, an ad decision point may occur at a point in time sufficiently before the ad insertion point. This assumes of course that the ad insertion is live and timed to coincide with the ad slots. In a predictive embodiment, it is possible to pre-load ad slots with commercial advertising before a program becomes available and then monitor the real time statistics to determine if an ad will be pulled or switched out with other advertising. There are many possibilities.

Consumers who interact with advertising served to them while viewing a program may, by default, be directed via one of their edge devices, for example, available computer or cell phone to contact center 105 for treatment. If a computer edge device is used for contact, it may be caused to navigate to a Web service maintained by center 105 where agents are on hand to engage consumers in instant message sessions, VoIP, or live chat. Connected cell phones may be caused to dial a number for the contact center to be answered by agents standing by to handle incoming calls. Interaction may be handles through CPE HDTVs if equipped with communications and Web navigation technologies.

To enable secondary device activation resulting from ad interaction, there may be some degree of software or hardware integration provided between the edge devices. For example, running the devices through a central hub, universal remote control, or a set top box where the status of each device is known and each device may communicate to other devices on the hub. Therefore, when a consumer clicks on a call button interacting with the television ad, the television may send a message to the cell phone to auto-dial the number relevant to the advertisement. Likewise, if the second device is a computer, a message may be sent that causes the computer to auto-navigate to a Web site for treatment.

In one embodiment, the system as a capability of determining which of the other edge devices to use to initiate contact with an agent standing by to treat a consumer who has interacted with an advertisement. For example, a consumer selects to interact with an ad served in television programming. The service determines which of the consumer's edge devices can be best used to engage live contact. If both devices are online, one device might be busy such as the cell phone. The computer may then be selected to initiate the contact with the contact center that will service the advertisement.

The same routing intelligence can be used in outbound contact campaign scenario wherein an outbound contact system calls a consumer telephone or sends an IM or chat invite based on availability of one or the other devices. Device availability of the consumer edge devices may be determined from the carrier as part of the consumer statistics for each program viewer. One with skill in the art will recognize that the present invention is not limited to television time-based ad delivery. The invention can be practiced with advertising that is not dependant on the programming that consumers may or may not be viewing.

Opportunistic ad placement with two-side statistics processing may be practiced using dynamic ad placement to consumer phones, computers or televisions over a delivery network such as network 101. For example, an ad may be an overlay advertisement that can be displayed over any program being viewed such as in a small window or on a title bar. Consumer statistics then may comprise more consumers than those that are watching a particular program. However, advertisement sales traditionally rely on viewership and other program related relationships with consumers to set pricing for advertisement opportunities.

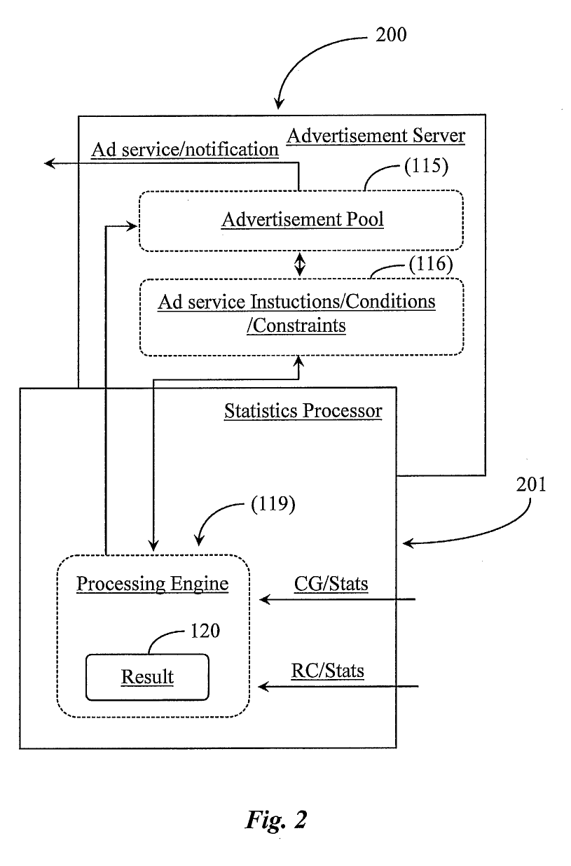

FIG. 2 is a block diagram illustrating statistics processing for ad service instruction determination for advertisement delivery according to an embodiment of the present invention. In one embodiment of the present invention, advertiser (103) of FIG. 1 above contains an advertisement server 200. Advertisement server 200 may contain or may be connected to an advertisement repository or an advertisement pool containing advertisements for service. In this embodiment, advertisement pool is identified with the element number 115 representing ads 115 of FIG. 1.

Advertisement server 200 includes ad service instructions (116), which may also include conditions and constraints placed on the service instructions of one or of more than one advertisement. Instructions 116 are received at the advertisement server from the advertiser along with advertisements for service. The ad service instructions identify the one or more advertisements that they relate to and before ad service is carried out for any advertiser, both the advertisement service instructions and at least identification of the advertisements that the instructions relate to are known to the server.

In this embodiment, server 200 includes or is connected to a statistics processor 201. Statistics processor may be internal to server 200 (processing server) or may be an external processor or processing machine that the server has some control over. Statistics processor 201 includes statistics processing engine 119 also described in FIG. 1. It is noted herein that the advertiser and advertisement service may be separate entities connected by contract or they may be combined within a single entity. In one embodiment, for example, the carrier of programming may also be the advertisement placement service and may control the ad servicing for advertisers it markets advertising space to.

In this embodiment advertisement server 200 receives ad service instructions, conditions, and constraints 116. Ad service instructions identify the appropriate ad or ads 115 for service according to those instructions. The ad(s) identifier could be a number, a code snippet, or an advertiser name. Server 200 has the programming schedule of the carrier “head-end” and access to the programming stream for practicing time-based ad insertion into the programming. In one embodiment, actual ads may be held at the carrier head end and server 200 serves an ad insert notification to the carrier head end, which then inserts the correct advertisement according to instructions.

In this example, statistics processor 201 receives consumer group (CG) statistics, which are analogous to consumer stats 118 previously described from the carrier. Consumer statistics may also come from a third party stat server authorized to obtain consumer statistics relative to consumers positioned to receive advertisements. Statistics processor 201 also receives response capability (RC) stats analogous to RC stats 117 described earlier. These stats may be received just before an ad decision point in the process. The ad decision point may be any pre-defined point in time before the ad insertion point in a programming stream.

Processing engine has access to the ad service instructions 116 and the statistics about the consumers and response capabilities of the contact center or other entity responsible for treating consumers who will respond to the served advertisements. Processing engine 119 processes the statistics received against any conditions or constraints in instructions 116 and produces a result 120. Result 120 may comprise a decision about which ad or ads to serve along with identification of an instruction set for serving those ads. Result 120 is forwarded to the ad sever and ad server 200 serves the ad or ads into the appropriate ad insertion points in the programming stream or streams. In one embodiment ad service notification is sent instead of actual ads. In this case, the carrier inserts the advertising according to the instructions in the notification which include the identification of the ad or ads to be served.

It is important to note herein that IPTV may include multi-cast programming according to schedule and the ad instructions may include instructions for serving one ad into an ad insertion point for some consumers and another ad in the same ad insertion point for other consumers. It is also noted herein that some programming may be ordered on demand by consumers in video on demand (VOD) situations. Pay per view (PPV) and VOD programming may be commercial free relative to timed commercial spots or slots that must be filled with some commercial advertising. However, advertising may still be delivered to consumers who order PPV programming and VOD programming using a time-based delivery system where the ads, instead of replacing the program, run alongside the program in a side bar, a separate window, or in some text scrolling manner such as across the bottom of the video screen. Such special advertising may be allowed by consumers who order PPV and VOD programming in exchange for some discount on the programming purchased.

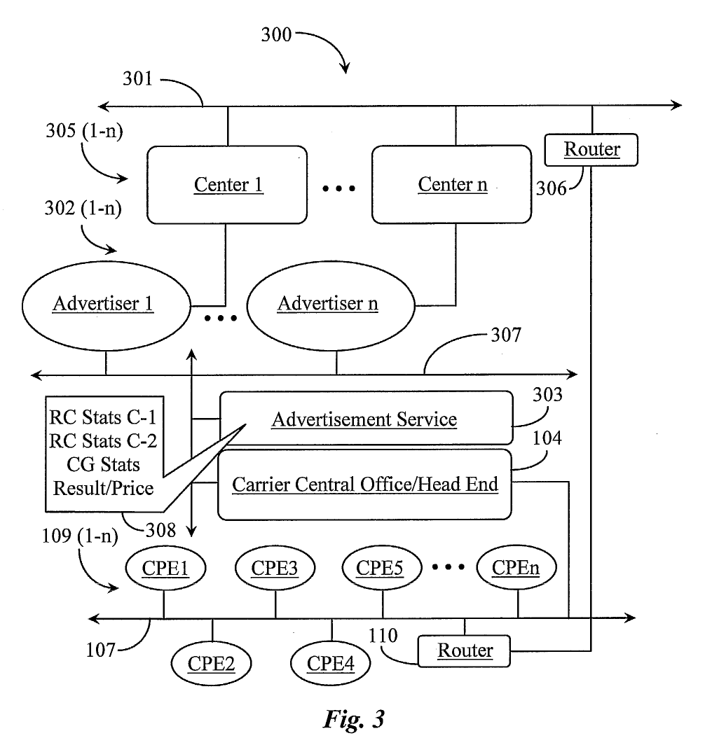

FIG. 3 is an overview of an advertisement delivery network system 300 according to another embodiment of the present invention. Network system 300 includes some of the same elements described above with reference to FIG. 1. Those elements shall retain the same element numbers and shall not be reintroduced. Network system 300 includes delivery network backbone 107 and CPE 109(1-n) and router 110. Carrier 104 delivers programming and provides other IP services to CPE 109(1-n) as previously described.

In this example, multiple advertisers 302(1-n) compete with one another for advertisement space. Multiple contact centers 305(1-n) are positioned to treat consumers who interact with advertisements. An advertisement service 303, which may include one or more advertisement servers such as server 200 described above has a network connection to carrier 104 and a network connection to advertisers 302(1-n). Advertisers in this embodiment may maintain their own call in centers or may contract those services out as previously described. Advertiser 301(1) has association with center 305(1) and advertiser 302(n) has association with center 305(n) in this logical illustration. It is clear that one advertiser may have more than one responder location or center and that one center may service more than one advertiser. The association illustrated in this example is meant to be logical only to show that an advertiser has or is associated with the resources for responding to consumers that have opted to interact with the advertising.

In one embodiment, advertisement service sells ad space on a competitive basis to advertisers. However, advertisers may pay differing prices for certain spots based on conditions and constraints and results of statistics processing. In one case a final price for inserting an advertisement or advertisements into an ad slot or position may be determined only at an ad decision point before actual ad insertion in an opportunistic and dynamic environment.

Advertiser 1 and advertiser n may be competing or “bidding” for the same set of advertising slots carried in a particular programming that consumers will view at a scheduled time. In this case, advertisement service 303 has ad service instructions and identified ads for insertion from both advertisers. Depending upon instructions, conditions, and constraints, ads from either advertiser 1 or advertiser n may be a best fit for one or more of the programming slots or ad insertion points after statistics are processed. In this case, CG stats are obtained by ad service 303 for the first program slot, for example, and RC stats from both advertisers are obtained. Statistics processing may determine in this case, which advertiser will benefit most from advertising in the particular program slot based on group statistics, response capabilities, advertising conditions and advertising constraints.

The carrier in this case may be willing to charge differently for advertising space based on or more preferences or conditions imposed by advertisers relevant to ad pricing. A typical ad slot in a particular program may start at an average price and more than one advertiser may reserve the slot for advertising. At the time of advertisement insertion however, it may be that one advertiser is better positioned to benefit from ad service than another or the other advertisers vying for the same slot. This determination may be made based in part on CG statistics, RC statistics, and how these statistics relate to any conditions in ad service instruction.

It may be that CG statistics favor one advertiser over another, but RC statistics of the favored advertiser indicate that advertiser cannot handle live interactions at the moment. The next favored advertiser having positive RC statistics may then win the ad space for which the calculations were performed. Likewise, pricing for the ad space may be determined based on predicted performance of the ad space or how well the statistics favor the advertiser. For example, an advertiser wants to place an ad in ad space relative to a program based on a minimum number of consumers viewing the program that are also customers of the advertiser. If statistics show that there are enough viewers that are also customers, the advertiser wants to run a special ad to them and handle responses using a live outbound call campaign. The advertiser is willing to pay a premium for that spot to those consumers who are also customers because of an expected much higher opt-in rate.

If statistics show that there are not enough viewers who are also customers then the advertiser is willing to run a second priority cold advertisement but expects to pay a lower price for the ad space. Another variation is that the advertiser may run the special ad to existing customers and the lower priority ad to the rest of the viewers. The advertiser predicts then, a viable number of viewers who are existing customers that will justify, from a profit opportunity standpoint, the running of the special ad and hopefully keep agents busy fulfilling the goal of the ad.

It is not required that an advertiser fill up every slot with an advertisement. There may be periods during a program when all of the advertiser's resources are busy handling events spawned from the previous ad insertion. RC stats would then show that no one is expected to be available to handle further interactions for some period of time. The advertiser may specify a condition to that effect for not serving an advertisement. The carrier may then insert some other advertising instead.

One goal of the present invention is to be able to target consumers who are motivated and will engage in live interaction at the time of ad placement. Advertising may be created especially for a group of consumers who fit a “motivated” profile. For example, consumers who already own a previous version of an advertiser's product or service but can be upgraded to a new version of the product or service with a quick live interaction may be considered motivated. The opt-in rate for those consumers would be much higher than the opt-in rate for consumers shown a “cold” advertisement meaning that no intelligence suggests that the consumer would respond. There are many possible combinations of motivations, conditions, and constraints that an advertiser might weave into one or more sets of instructions for ad placement. The exact array of possible options for advertising would depend on an agreement between the parties involved.

Referring now back to FIG. 3, before selecting and placing an advertisement in this case, advertisement service 303 runs CG stats and two sets of RC stats. One set of RC stats is from call center 1 and the other set is from call center n. All things being equal, the RC stats may ultimately determine which advertiser will command an ad slot. For example, if center n cannot respond because all of its resources are busy, then advertiser 1 may win the slot with interaction events going to center 1 for fulfillment. It may be that the carrier or advertisement service desires advertising where there is always live assistance and good quality service in order to build a reputation and make its advertising space more valuable. Therefore, the carrier or the advertisement service may have a hand in setting some of the conditions for ad services such as a requirement that the advertiser be able to service requests live with a minimum amount of waiting time.

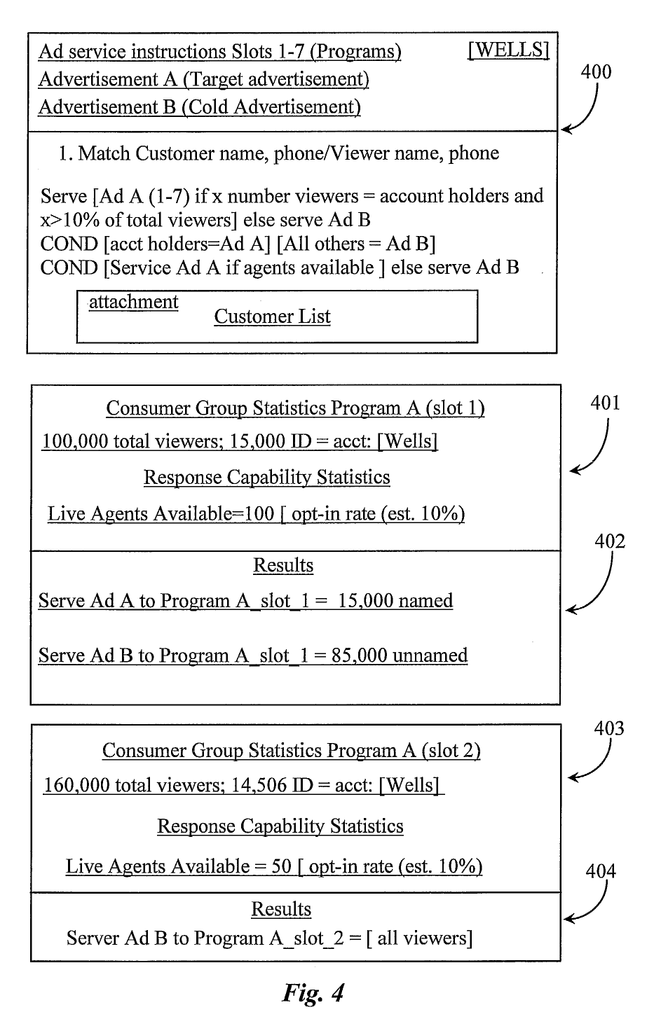

FIG. 4 is a block diagram illustrating ad service delivery statements made according to advertisement delivery instructions and statistics processing. A set of service instructions 400 is illustrated. At the top of the instruction set the advertiser is identified by a pseudo name WELLS. The ad service instructions are specific in this case to slots 1-7 for a specific program or programs. The ad service instructions specify 2 advertisements, advertisement A, which is a target advertisement, or “special” advertisement and advertisement B, which is a cold advertisement.

Instruction set 400 has a customer list attached that contains a list of consumers who are customers of the advertiser. A first instruction is for the advertising service to match names and telephone numbers of customers from the list to name and telephone numbers of viewers of the program containing the 7 advertising slots. Instruction set 400 includes a conditional statement that directs the advertiser to serve ad A in all 7 slots if a specific number of viewers are account holders with the advertiser and that number is also more than 10% of the total number of viewers. If statistics do not validate the statement then serve ad B in all 7 slots.

In this case, if the instruction for serving ad A is validated by consumer statistics taken at or just before an ad decision point before the first ad slot, there are two more conditions attached to the service instructions. The first one is to serve ad A to the account holders and ad B to all of the other viewers for each slot. A second condition attached to the service instruction for ad A is that agents must be available to service account holders that interact with the ad and if no resources are available, just serve ad B.

Consumer and response capability statistics 401 are fed into the stat processing engine. The stat processing engine processes those stats against the instruction set 400. Consumer group statistics and response capability statistics are in this case consulted before each of the 7 slots for program A to consider service of ad A, ad B or both ads. CG stats show that of 100,000 total viewers, 15,000 name telephone number pairs of viewers match those on the attached customer list. Therefore, 15,000 viewers are also WELLS customers. RC stats show that live agents are available to answer ad A, which is the only ad specified for live treatment. The expected opt-in rate for account holders of Wells is estimated to be 10%.

A results statement 402 is generated by the stat processing engine that specifies the ad or ads to be served into which slot for which program. In this case, 15,000 placements of ad A and 85,000 placements of ad B are run. The difference between ad A and ad B may be that ad A is a special ad targeting customers of the advertiser who are also viewing programming while ad B may be a cold ad letting potential customers know about the services of the advertiser and providing a Web site for them to navigate to for more information.

It should be noted herein that actual advertisements may be inserted at the head-end, where the original programming stream splits for multicasting, or at CPE. In the later case ad notification may be sent to CPE such as a set top box, for example, and the set top box may order the appropriate ads from the advertiser or carrier. In this case specialized advertising may be inserted into the ad slots at the consumer CPE location.

In this case, statistics processing occurs before each ad slot. Therefore, a second processing of statistics takes place before the ad insertion point of slot 2 in the same program A. Statement 403 includes new or updated consumer group statistics for program A slot 2. Between the first and second commercial slot, 60,000 more viewers began watching program A. However, the total number of consumers who are also account holders with the advertiser dropped below 15,000. RC stats show live agents available at 50 with the same estimated opt-in rate of 10%. Presumably 50% of the original 100 agents are still busy handling calls from the campaign.

In the result statement 404, ad A is not served. This is because the total number of viewers who are also account holders was not greater than 10% of the total, a condition set by the advertiser for servicing ad A. Therefore, the result for slot 2_program A is to server only ad B to all viewers. Instruction set and conditions 400 and statistics and result statements 401-404 are meant as examples only. Ad service instructions, conditions, statistics, and results may vary widely according to the ad service embodiment. For example, more than one advertiser may be involved in competition for ad space. One ad may not be allowed to run in more than a few ad spaces per program. Ads may run “on top” of programming rather than in designated ad slots or both applications may be practiced during a same program

In one embodiment of the invention ad service for a single advertisement may be paced or throttled according to response capability. Such an algorithm might run on the advertisement server and would be fed by RC statistics and enterprise rules. In a pacing embodiment, the ad service result statement might be to server ad A into slot 2, 4, and 6 of program A with ad pacing “on” during the service period. In this case, RC statistics are monitored during and after the initial service into the first slot. Statistics considered for pacing may include actual opt-in rate statistics, estimated waiting time for live response, average handling time of interactions currently being handled, % of agent involvement in the campaign relative to other duties, current call abandonment rate, % of calls answered resulting in no fulfillment, and so on. One or a combination of such statistics that change as a campaign ensues can be tapped and used by a pacing algorithm to, for example, reduce the number of advertisements served from the number served in the previous slot.

A simple example might be that an advertiser paid for slots 2, 4, and 6 as described above for receiving service of ad A into program A. According to consumer and RC statistics run before the first ad insertion point, perhaps 20,000 ads go out in the first slot. Now before servicing the second slot, the pacing algorithm determines if there should be a reduction or throttling of the number of ads served at the second ad insertion point or slot 4. The rate of calls abandoned may have increased significantly since the first ad service as more agents are busy. Likewise, EWT for a live agent to pick up a call from queue may have also increased. According to rules based on maintaining a specific service level objective for running the campaign, the algorithm may process the most current RC stats and conditions against SLO rules and may curb the number of ads going out into the next service point. In this case, Consumer stats and original RC stats dictate the ad service instructions and conditions for slot 2, but continued RC monitoring with pacing on determines if any ad pacing will occur for the subsequent slots.

Perhaps a higher call abandonment rate coupled with a higher EWT and relative higher opt-in rate expectation may force a reduction of 50% so only 10,000 ads go out to slot 4. If by the time slot 6 is considered, conditions have improved then the original number may be restored for the last slot. The goal of pacing is proactive advertisement placement based on RC statistics and conditions. The advertiser wants to reduce call abandonment rate, maximize use of campaign resources, and hopefully increase call fulfillment rates according to the goal of the advertisement. If too many calls come in agents won't be able to respond and EWT may increase beyond the customers capacity to wait causing dissatisfaction and possible alienation of potential customers. On the other hand if too few calls come in, the campaign is not meeting SLO and agents are sitting around waiting for business.

In one embodiment of the invention, historical analysis may be practiced to fine tune RC statistics. For example, at or before an ad decision point in a campaign where an ad was already served new RC statistics might be available regarding historical opt-in rates, average time to answer, average time for call handling, and so on for the specific campaign being run. These statistics can be used to “predict” response capability at least over the short run. In such a case, current RC stats may indicate that there are actually no live agents available to service calls. However, it is likely that 20 agents will become available over the next 2 minutes, so the result is “live agents available”. In this case an ad may run under the presumption that agents will become available within an acceptable time frame from ad service.

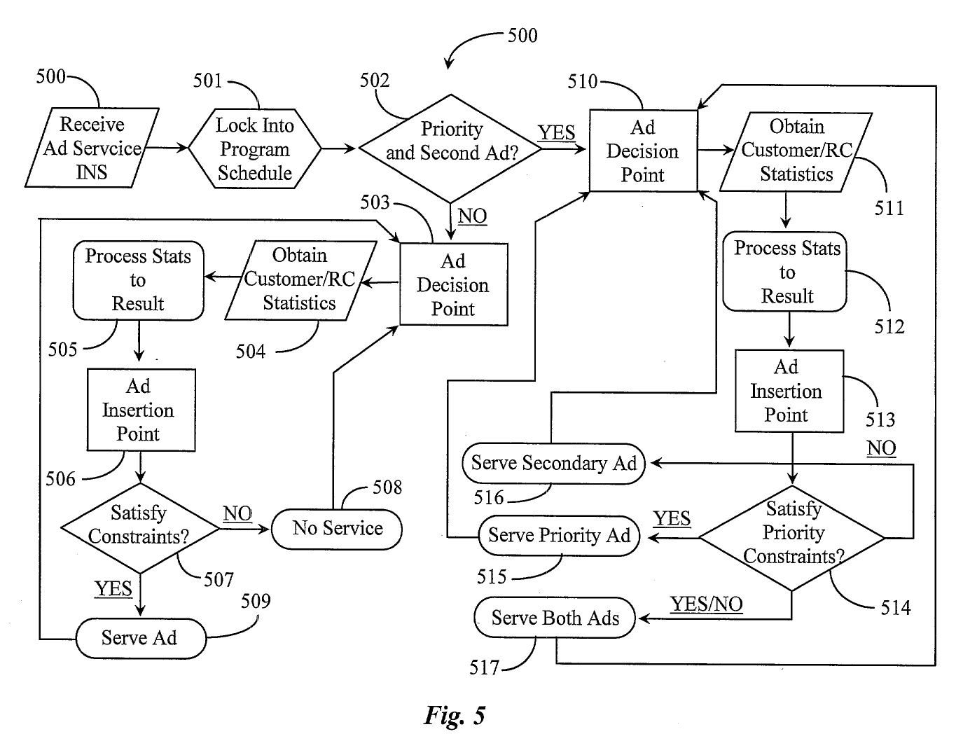

FIG. 5 is a process flow chart illustrating steps for determining ad service according to embodiments of the present invention. At step 500 and advertisement placement service receives an ad or ads and service instructions and conditions for ad service placement. In one embodiment, the ads are held by the advertisement placement service in a repository adapted for the purpose and those ads are actually served by an ad server into the programming delivered to consumers. In another embodiment, the ads are held local to the head end and the advertisements service has only identifications of the advertisements and serves an ad notification of which ads to insert into programming.

At step 501, assuming actual advertisements are placed by an ad placement service, the ad placement service locks into program scheduling and obtains access to programming subject to advertisements placement. At step 502, the advertisement placement service may determine if the ad or ads to be placed comprise a single ad to consider or multiple ads to consider such as a priority ad and a secondary ad. In a variation of this process, step 502 may determine if an ad or ads to be inserted are from a single advertiser or are multiple advertisers competing for ad placement.

At step 502, the ad placement service may determine that there is a single advertisement (NO) or that there are multiple advertisements (YES). In either event, the process branches accordingly to step 503, which is a first ad decision point where a single ad is considered, or to step 510, a first decision point where multiple ads are considered.

At the ad decision point 503, the advertisement placement service obtains customer and response capability statistics at step 504. At step 505, the advertisement placement service processes the stats to a result against the ad service instructions and conditions for the ad to be served. At step 506, an ad insertion point arrives in the programming. At step 507, the advertisement placement service makes a determination based on the result of processing in step 505 if the statistics result satisfies the instructions and conditions for serving or for not serving the advertisement at the ad insertion point.

In actual practice, the result may simply be a statement identifying a specific instruction for service and will comply with one or another option for ad service listed in the instruction set received at step 500. If the result of processing does not satisfy one or more conditions or constraints for ad service, then at step 508 the advertisement is not served. In this case, another generic advertisement may be served instead. The ad that may be inserted just to fill the slot may not be the advertiser's ad or ads of step 500.

At step 507, if it is determined that the processing result of step 505 does satisfy service conditions or constraints, then the advertisement is served accordingly at step 509. In a case where the options are to serve or not to serve the ad such as in this branch of the process, some generic advertising could be on hand to fill ad space if the advertiser opts out of filling the ad space based on the processing result.

If at step 502, there is more than one advertisement to consider such as a priority advertisement and a secondary advertisement, such as a cold advertisement, then as previously described the process branches accordingly with the next step being an ad decision point at step 510. At step 511 the advertisement placement service obtains the consumer and RC statistics and at step 512 the advertisement service processes those statistics to a result against one or more instruction options, and conditions or constraints. In this branch the instructions received at step 500 would include the options for servicing the multiple ads and identification of those ads.

At step 513, a first ad insertion point arrives. For both branches of this exemplary process it is assumed that ad decision points and ad insertion points are time-based. At step 514, the advertisement placement service determines if the result of statistics processing satisfies the conditions for serving the priority advertisement. If so then the priority advertisement is served at step 515 according to the instructions. If at step 514, the result does not satisfy the conditions for serving the priority advertisement, then at step 516, the secondary advertisement is served instead. It is also possible that the result satisfies a limited service for the priority ad and a condition exists for also serving the secondary advertisement (YES/NO). In such a case where conditions specify, both advertisements may be served at step 517, the priority advertisement served to selected consumers who are identified that qualify to receive the priority advertisement and the secondary advertisement served to all other consumers not selected to receive the priority advertisement. The mechanics of this type of service may depend on ad service placement at points in the programming after the head end stream has been multicast to the specified consumers. In one embodiment, CPE at the consumer end receives the appropriate advertisement for the ad slot and coordinates the presentation accordingly.

It will be apparent to one with skill in the art that the opportunistic advertisement placement system of the invention may be provided using some or all of the mentioned features and components without departing from the spirit and scope of the present invention. It will also be apparent to the skilled artisan that the embodiments described above are specific examples of a single broader invention which may have greater scope than any of the singular descriptions taught. There may be many alterations made in the descriptions without departing from the spirit and scope of the present invention.

What is claimed is:

1. A method for determining advertisement placement service instructions for placing an advertisement comprising the steps:
(a) receiving from an advertiser, one or more advertisements and a set of conditional service instructions;
(b) monitoring consumers positioned to receive the one or more advertisements and compiling statistics about them as a group;
(c) before a pending advertisement service point, receiving statistics about response capabilities for handling interactions resulting from a served advertisement;
(d) before the pending advertisement service point of step (c), comparing the consumer group statistics with the response capability statistics against at least one rule; and
(e) delivering or not delivering an advertisement of the one or more advertisements of step (a) at the advertisement service point of step (c) using one or more of the conditional service instructions based on the result of step (d).

2. A method for selecting an advertisement for insertion into a time slot available to more than one advertiser comprising the steps:
(a) receiving from the advertisers, an advertisement and a set of conditional service instructions;
(b) monitoring consumers positioned to receive the one or more advertisements and compiling statistics about them as a group;
(c) before the time slot occurs, receiving response capability statistics from all associated centers assigned to handle advertisement interactions resulting from advertisement service;
(d) before the time slot of step (c), comparing each of the center's response capability statistics with the consumer group statistics against at least one rule; and
(e) selecting an advertisement for insertion into the time slot, the advertisement pre-assigned to an associated center according to the result of step (d).

3. A system for dynamic advertisement placement to a base of consumers comprising:
an advertisement server for causing service of advertisements to the consumer base; and
a statistics processor coupled to the advertisement server;
characterized in that the advertisement server receives consumer group statistics from consumers positioned to receive advertisements, and receives response capability statistics from one or more centers positioned to respond to consumers who interact with advertisements served and processes those statistics using the statistics processor against at least one rule to determine advertisement service instructions for serving or for not serving particular advertisements.

4. A network-based processing server for processing statistics and serving advertisements comprising:
a first network interface to a first stat server for receiving consumer statistics;
a second network interface to a second stat server for receiving response capability statistics; and
a dedicated input/output port connecting the processing server to a broadcast network;
characterized in that the processing server selects and serves advertisements over the broadcast network to consumers positioned to receive the advertisements based on the processing of consumer statistics and advertisement response capability statistics against at least one rule.

5. A method for controlling deployment parameters of an advertisement created for a consumer base and served by an advertisement placement service comprising the steps:
(a) providing a set of advertisement service instructions and constraints to an advertisement placement service;
(b) providing response capability statistics relative to the advertisement to the advertisement placement service;
(c) providing consumer group statistics about consumers positioned to receive the advertisement to the advertisement placement service;
(d) at the advertisement placement service, processing the statistics provided in steps (b) and (c) against at least one rule;
(e) selecting from the service instructions and constraints of step (a) those that will be used in deploying the advertisement based on the result of step (d); and
(f) repeating steps (b) through (e) before each subsequent period of advertisement placement.
